(19) United States
(12) Patent Application Publication
(10) Pub. No.: US 2006/0181498 A1
(43) Pub. Date: Aug. 17, 2006

(54) Display device

(75) Inventors: Noboru Toyozawa, Kanagawa (JP); Yoshiharu Nakajima, Kanagawa (JP); Hirotoshi Koyama, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 10/541,092

(22) PCT Filed: Dec. 24, 2003
(86) PCT No.: PCT/JP03/16604

§ 371 Date: Jun. 29, 2005

(51) Int. Cl. G09G 3/36

(52) U.S. Cl. 345/98

(57) ABSTRACT

A display device is formed by a panel in which a display area and a peripheral circuit part for driving the display area are integrally formed in an integrated manner on an insulating substrate 1. The display area includes pixel electrodes arranged in a form of a matrix, a common electrode opposed to the pixel electrodes, and an electrooptic material retained between the pixel electrodes and the common electrode. The circuit part includes a driver for writing a signal voltage to a side of the pixel electrodes according to display data, a common driver 5 for applying a common voltage to a side of the common electrode, an offset circuit 51 having a coupling capacitor C1 for generating a predetermined offset voltage ΔV to adjust the level of the common voltage with respect to the signal voltage, and a start circuit 52 for pre-charging the coupling capacitor C1 to an offset voltage ΔV at a time of a rising edge of power supply voltage and discharging the coupling capacitor C1 at a time of a falling edge of the power supply voltage. Thus, the start circuit for the common driver is included within the display device of a system display configuration, so that mounting can be rationalized.

### TECHNICAL FIELD

The present invention relates to a display device having a pixel electrode and a common electrode opposed to the pixel electrode, and, particularly, to an improved technique for a periphery of a circuit for generating an alternating-current common voltage to be applied to the common electrode.

### BACKGROUND ART

Flat-type display devices typified by conventional active-matrix liquid crystal panels are often used as a display part for an electronic device. An active-matrix-type display panel operates according to display data and power supply voltage supplied from a side of an electronic device proper, and it generally has a so-called system display configuration in which a display area and a peripheral circuit part for driving the display area are integrally formed in an integrated manner on an insulating substrate. In this case, the display area includes pixel electrodes arranged in a form of a matrix, a common electrode opposed to the pixel electrodes, and an electrooptic material, such as a liquid crystal or the like, retained between the pixel electrodes and the common electrode. On the other hand, the peripheral circuit part surrounding the display area includes a driver for writing a signal voltage to the pixel electrode side according to display data, and a common driver for applying a common voltage to the common electrode side. A display device having such a constitution is disclosed in Japanese Patent Laid-Open No. 2000-193941.

When a liquid crystal is used as electro-optic material, alternating-current driving is generally employed to prevent degradation of the liquid crystal material. The signal voltage applied to the pixel electrode side is inverted in polarity in each predetermined cycle, and correspondingly the common voltage also is inverted. Thus, a conventional common driver generates and inverts the common voltage in a predetermined cycle. The liquid crystal material and an active element such as a thin film transistor or the like for driving the liquid crystal material have asymmetry with respect to polarity. Therefore, when center potentials of the signal voltage and the common voltage exactly coincide with each other, the asymmetry becomes apparent with image degradation, such as an image burn, flicker or the like, becoming noticeable. Accordingly, an offset circuit having a coupling capacitor for generating a predetermined offset voltage to adjust the level of the common voltage with respect to the signal voltage is attached to the conventional display device in addition to the common driver. By setting the offset voltage so as to cancel the asymmetry with respect to polarity of the liquid crystal material and the active element, the image burn and flicker can be prevented.

When power to the display device is turned on, the coupling capacitor included in the offset circuit needs to be charged to a predetermined offset voltage. When the charging of the coupling capacitor is completed, the predetermined offset voltage is added to the common voltage output from the common driver, so that a proper image can be displayed. However, in a transient period from the turning on of the power to the completion of the charging of the coupling capacitor, the level of the common voltage is unstable, and thus a flicker can appear. In order to prevent this, a start circuit for quickly charging the coupling capacitor at the time of turning on the power is conventionally used. This start circuit is also used to discharge the coupling capacitor at a time of shutting off the power.

However, the conventional start circuit (quick charging and discharging circuit) for the common driver is realized by a driving system external to the display device having the system display configuration. In this case, there are problems of an increase in the number of parts and an increase in scale of the driving system external to the display device.

### DISCLOSURE OF INVENTION

In view of the above problems of the conventional techniques, it is an object of the present invention to include a start circuit for a common driver within a display device having the system display configuration. The following means are used to achieve the object. There is provided a display device used as a display part of an electronic device, operating according to display data and power supply voltage supplied from a side of the electronic device proper, and formed by a panel in which a display area and a peripheral circuit part for driving the display area are integrally formed in an integrated manner on an insulating substrate, the display device characterized in that: the display area includes pixel electrodes arranged in a form of a matrix, a common electrode opposed to the pixel electrodes, and an electrooptic material retained between the pixel electrodes and the common electrode; and the circuit part includes a driver for writing a signal voltage to a side of the pixel electrodes according to the display data, a common driver for applying a common voltage to a side of the common electrode, an offset circuit having a coupling capacitor for generating a predetermined offset voltage to adjust level of the common voltage with respect to the signal voltage, and a start circuit for pre-charging the coupling capacitor of the offset circuit to an offset voltage at a time of a rising edge of the power supply voltage, and discharging the coupling capacitor at a time of a falling edge of the power supply voltage. Specifically, the display area and the peripheral circuit part for driving the display area in the panel include thin film transistors formed on a common insulating substrate by an identical process, and the common driver, the offset circuit, and the start circuit are mounted on the common insulating substrate except for the coupling capacitor. Preferably, the start circuit operates only at the time of the rising edge of the power supply voltage and at the time of the falling edge of the power supply voltage, and it is in a non-operational state during other times.

Further, there is provided a display device used as a display part of an electronic device capable of switching between a normal power consumption state and a low power consumption state, operating according to display data and power supply voltage supplied from a side of the electronic device proper, and formed by a panel in which a display area and a peripheral circuit part for driving the display area are integrally formed in an integrated manner on an insulating substrate, the display device characterized in that: the panel can switch between an operational mode and a standby mode according to the switching of the side of the electronic device proper between the normal power consumption state and the low power consumption state; in the operational mode, the panel operates while supplied with the power supply voltage from the side of the electronic device proper, and makes a desired display by driving the display area; in the standby mode, the panel has standby control means for stopping the driving of the display area and inactivating the circuit part to reduce power consumption of the panel while the panel remains in a state of being supplied with the power supply voltage from the side of the electronic device proper; the display area includes pixel electrodes arranged in a form of a matrix, a common electrode opposed to the pixel electrodes, and an electro-optic material retained between the pixel electrodes and the common electrode; and the circuit part includes a driver for writing a signal voltage to a side of the pixel electrodes according to the display data supplied from the side of the electronic device proper, a common driver for applying a common voltage to a side of the common electrode, an offset circuit having a coupling capacitor for generating a predetermined offset voltage to adjust the level of the common voltage with respect to the signal voltage, and a start circuit for pre-charging the coupling capacitor of the offset circuit to an offset voltage in advance when a return is made from the standby mode to the operational mode, and discharging the coupling capacitor when a transition is made from the operational mode to the standby mode. Specifically, the display area and the peripheral circuit part for driving the display area in the panel include thin film transistors formed on a common insulating substrate by an identical process, and the common driver, the offset circuit, and the start circuit are mounted on the common insulating substrate except for the coupling capacitor. Preferably, the start circuit operates only when the return is made from the standby mode to the operational mode and when the transition is made from the operational mode to the standby mode, and it is in a non-operational state during other times.

According to the present invention, a system for quickly charging the coupling capacitor for offsetting the common voltage to be applied to the common electrode of the display device to a desired offset potential at the time of turning on power is included within the liquid crystal display device. That is, the display area and the peripheral circuit part for driving the display area in the display panel of the system display configuration include thin film transistors formed on a common insulating substrate by an identical process. The common driver, the offset circuit, and the start circuit belonging to the circuit part are formed with thin film transistors and the like in an integrated manner on the common insulating substrate except for the coupling capacitor. Depending on circumstances, a system display capable of switching between a normal operation mode and a standby mode is used. Also in this case, when a return is made from the standby mode to the operation mode, the coupling capacitor for shifting the common voltage needs to be charged quickly. The start circuit for this purpose can also be included in the display device.

### BRIEF DESCRIPTION OF DRAWINGS

FIG. 1 is a block diagram showing a general configuration of a display device according to the present invention;

FIGS. 2A and 2B are timing charts showing an on sequence and an off sequence of the display device;

FIGS. 3A and 3B are timing charts showing an on sequence and an off sequence of the display device having a standby mode;

FIG. 4 is a circuit diagram showing an embodiment of a start circuit included in the display device shown in FIG. 1;

FIG. 5 is a timing chart of an on sequence of the start circuit shown in FIG. 4;

FIG. 6 is a timing chart of an off sequence of the start circuit shown in FIG. 4;

FIG. 7 is a circuit diagram showing an embodiment of a start circuit ready for a standby mode;

FIG. 8 is a timing chart of an on sequence of the start circuit shown in FIG. 7; and

FIG. 9 is a timing chart of an off sequence of the start circuit shown in FIG. 7.

### BEST MODE FOR CARRYING OUT THE INVENTION

Embodiments of the present invention will hereinafter be described in detail with reference to the drawings.

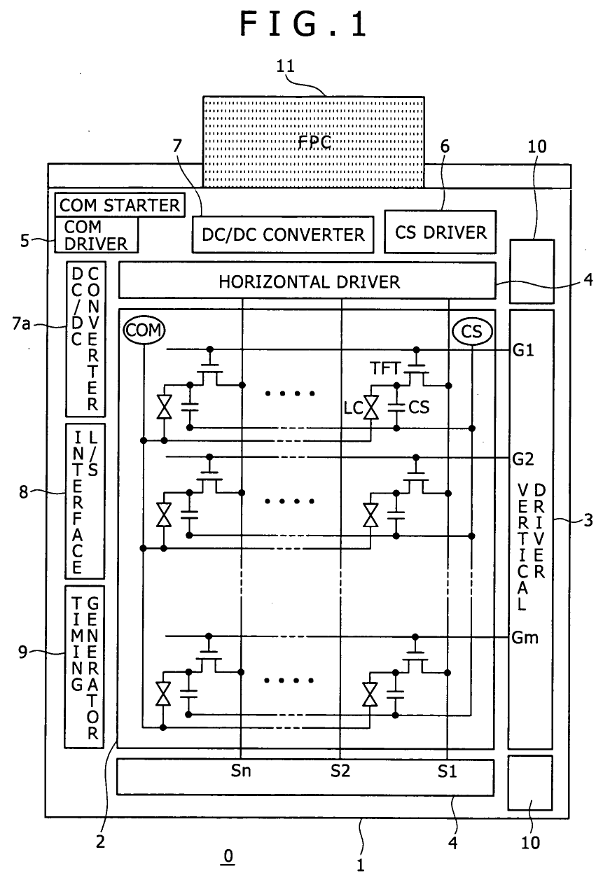

FIG. 1 is a block diagram showing a general configuration of a display device according to the present invention. As shown in the figure, the display device 0 is formed in an integrated manner on an insulating substrate 1 formed of glass or the like. A display area 2 is formed at a center of the insulating substrate 1, and a peripheral circuit unit is formed integrally with the display area 2 so as to surround the display area 2. A connection terminal is formed on a top side of the rectangular insulating substrate 1. The connection terminal is connected to a side of an electronic device proper (a set side) via a flexible printed cable (FPC) 11. The FPC 11 is a flat cable of a single-layer structure in which a plurality of wires are arranged in a plane.

The display area 2 has a matrix configuration in which gate lines G1 to Gm in rows and signal lines S1 to Sn in columns are arranged so as to intersect each other. A pixel is formed at an intersection of each gate line G and each signal line S. In the present embodiment, each pixel includes a liquid crystal element LC, an auxiliary capacitance CS, and a thin film transistor TFT. The liquid crystal element LC includes a pixel electrode, a common electrode (COM) opposed to the pixel electrode, and a liquid crystal (electro-optic material) retained between the pixel electrode and the common electrode. The TFT has a gate electrode connected to a gate line G, a source electrode connected to a signal line S, and a drain electrode connected to the pixel electrode of the liquid crystal element LC. The auxiliary capacitance CS is connected between the drain electrode of the TFT and an auxiliary capacitance line. The TFT conducts in response to a selection pulse supplied from the gate line G, and writes a signal voltage supplied from the signal line S to the pixel electrode of the corresponding liquid crystal element LC. The auxiliary capacitance CS retains the signal voltage during a period of one frame or one field.

The liquid crystal element LC is generally driven by an alternating current. That is, the signal voltage written to the liquid crystal element LC via the signal line S is inverted in polarity periodically. A common voltage VCOM applied to the common electrode COM of the liquid crystal element LC needs to be inverted in polarity periodically in synchronism with the signal voltage. The liquid crystal element LC and the TFT for switching-driving the liquid crystal element LC are asymmetric with respect to polarity. Therefore, when center levels of the pixel electrode side and the common electrode side coincide with each other, the asymmetry with respect to polarity appears and causes image degradation, such as an image burn. As a measure against this, the common voltage VCOM is offset by a predetermined voltage amount with respect to the signal voltage to cancel out the asymmetry with respect to polarity. Incidentally, the auxiliary capacitance CS also needs to be operated by an alternating current in synchronism with the alternating-current driving of the liquid crystal element LC. Therefore, a voltage inverted in polarity in predetermined cycles also needs to be applied to the common auxiliary capacitance line connected to each auxiliary capacitance CS.

The peripheral circuit unit is formed in an integrated manner at four sides, that is, a top side, a bottom side, a left side, and a right side surrounding the above-described display area 2. In the present embodiment, the peripheral circuit unit includes, for example, a vertical driver 3, a horizontal driver 4, a COM driver 5, a CS driver 6, a DC/DC converter 7, a DC/DC converter 7a, an interface 8 including a level shifter (L/S), a timing generator 9, and an analog voltage generator 10. However, the present invention is not limited to this configuration; a necessary circuit is added as appropriate according to a specification for the display device (system display) 0, while an unnecessary circuit is omitted. For example, a driver for generating signal voltage levels used for a complete white display and a complete black display separately from the signal voltage may be incorporated.

The vertical driver 3 is connected to the gate lines G1 to Gm to supply a selection pulse on a line-sequential basis. The horizontal driver 4 is formed by a pair of an upper part and a lower part. The horizontal driver 4 is connected to both ends of each of the signal lines S1 to Sn to supply a predetermined signal voltage from both ends simultaneously. Incidentally, the signal voltage corresponds to display data (image information) transmitted from the set side via the FPC 11.

The common driver (COM driver) 5 applies the common voltage VCOM inverted in polarity periodically to the common electrode common to each liquid crystal element LC. An offset circuit and a start circuit (COM starter) are attached to the COM driver 5. The offset circuit adjusts an offset level for the common voltage generated by the common driver 5. The start circuit (COM starter) charges the offset circuit at a time of starting the panel to start the application of the common voltage VCOM quickly. The CS driver 6 applies a voltage periodically inverted in polarity to the auxiliary capacitance line common to each auxiliary capacitance CS.

The DC/DC converter 7 converts a primary power supply voltage supplied from the electronic device proper via the FPC 11 into a secondary power supply voltage in accordance with a specification for the panel (display device 0). The DC/DC converter 7 is used particularly for conversion of a positive-side power supply voltage VDD. On the other hand, the DC/DC converter 7a is used for conversion of a negative-side power supply voltage VSS.

The interface 8 including the L/S receives control signals such as a clock signal, a synchronizing signal, an image signal and the like supplied from the set side via the FPC 11. The level shifter L/S shifts levels of the control signals (external control signals) sent from the set side to generate control signals (internal control signals) conforming to specifications for circuit operation within the display device. In the present specification, when the external control signals need to be differentiated from the internal control signals, a number (3) for an external control signal and a number (5) for an internal control signal may be attached following a symbol indicating the type of each control signal. The timing generator 9 processes the clock signal and the synchronizing signal sent from the interface 8 including the L/S to generate, for example, a clock signal necessary for timing control of each circuit part. The analog voltage generator 10 supplies the horizontal driver 4 with analog voltages at a plurality of levels corresponding to gradation levels in advance. The horizontal driver 4 writes the gradated analog signal voltages to the liquid crystal element LC according to image information supplied from the side of the electronic device proper.

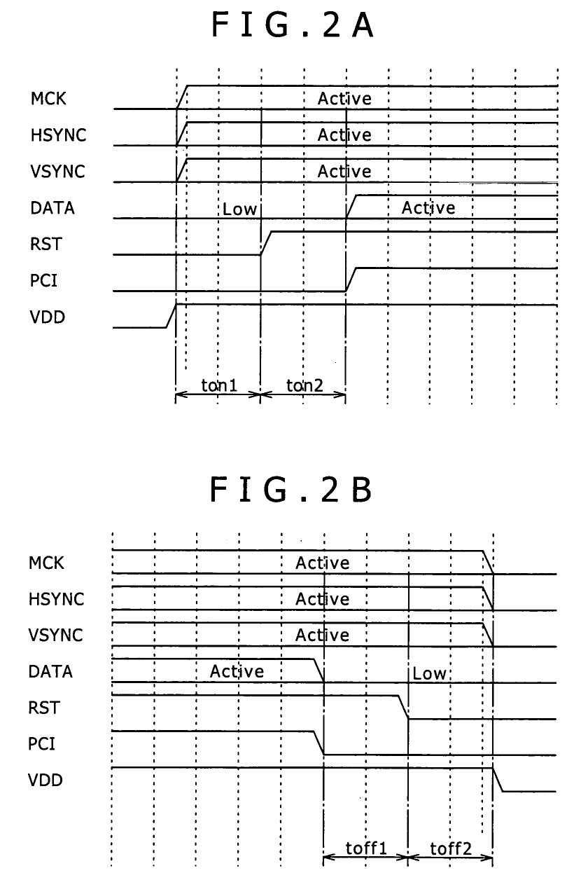

FIGS. 2A and 2B are timing charts of sequences of control of the display device side by the set side. FIG. 2A represents an on sequence. FIG. 2B represents an off sequence. FIGS. 2A and 2B represent a normal case where there is no sequence control for a standby mode. The display side is supplied with a master clock MCK, a horizontal synchronizing signal HSYNC, a vertical synchronizing signal VSYNC, display data DATA, a reset signal RST, a display permitting signal PCI, and a power supply voltage VDD from the set side according to the predetermined sequences. In the on sequence (A) for starting the display side by the set side, the VDD rises first, and then the MCK, the HSYNC, and the VSYNC become active. After passage of a time ton1, the reset signal RST is changed from a low to a high to initialize the circuit part of the display. Then, after passage of a time ton2, the DATA is changed from a low to an active state, and the display permitting signal PCI is changed from a low to a high. Thereby an image appears in the display area of the display.

In the off sequence (B) for turning off the display by the set side, the DATA is first changed from an active state to a low, and the display permitting signal PCI is changed from a high to a low. After passage of a time toff1, the reset signal RST is changed from a high to a low to reset an internal state of the circuit of the display. After passage of a time toff2, supply of the MCK, the HSYNC, and the VSYNC is shut off, and finally the VDD falls. Thereby the VDD becomes a ground potential or a floating potential.

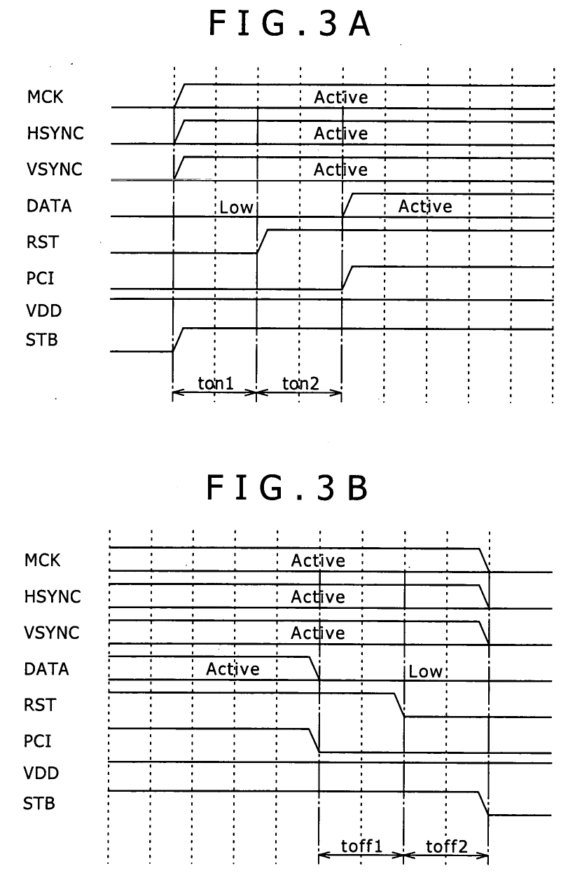

FIGS. 3A and 3B are timing charts of an on sequence and an off sequence in which a standby mode is used. In order to facilitate understanding, parts corresponding to those of the ordinary on sequence and the ordinary off sequence shown in FIGS. 2A and 2B are identified by corresponding reference characters. The set side can be switched between a normal power consumption state and a low power consumption state. The display side needs to be correspondingly controlled to be switched between an operational mode and a standby mode. For this purpose the set side inputs a standby signal STB to the display side.

In an on sequence (A), the standby signal STB first rises from a low to a high, so that the display returns from the standby mode to the operational mode. In synchronism with the rising of the STB, an MCK, an HSYNC, and a VSYNC become active. However, a VDD is supplied at all times irrespective of the STB. After passage of a time ton1, an RST is changed from a low to a high to initialize the circuit state of the display. After passage of a time ton2, DATA becomes active, and a PCI is changed to a high. Thereby an image appears in the display area.

In an off sequence (B), the DATA and the PCI become inactive. After passage of a time toff1, the RST is changed from a high to a low to reset the internal circuit of the display. After passage of a time toff2, the STB is changed from a high to a low, and the MCK, the HSYNC, and the VSYNC become inactive. When the STB is changed from a high to a low, the display side makes a transition from the operational mode to the standby mode. On the other hand, the VDD is maintained at a power supply voltage at all times even though the transition to the standby mode is made.

Thus, in a system using the standby mode, a driving circuit system of the display side is inactivated according to the STB while the VDD is maintained in an active state. The signal STB used for standby mode control can be a control signal input independently from the set side as shown in the figures, or it can be generated by internal logical processing on the display side of another external signal supplied from the set side. In the off sequence, the internal circuit of the display is logically reset by the RST, and thereafter the STB falls. At this time, the master clock MCK, the synchronizing signals HSYNC and VSYNC and the like supplied from the set side are changed from an active state to be fixed at a certain potential. While the master clock MCK, the synchronizing signals HSYNC and VSYNC and the like are fixed at a low level (GND level) in the example shown in the figure, the master clock MCK, the synchronizing signals HSYNC and VSYNC and the like may be fixed at a VDD level in some cases.

The display device, which makes a transition to the standby mode in response to the falling of the standby signal STB, has standby control means for stopping the driving of the display area and inactivating the circuit part to reduce panel power consumption while in a state of being supplied with the power supply voltage VDD from the side of the electronic device proper. This standby control means is distributed in blocks of the circuit part, and each circuit block performs a control sequence for inactivation in response to the falling of the STB.

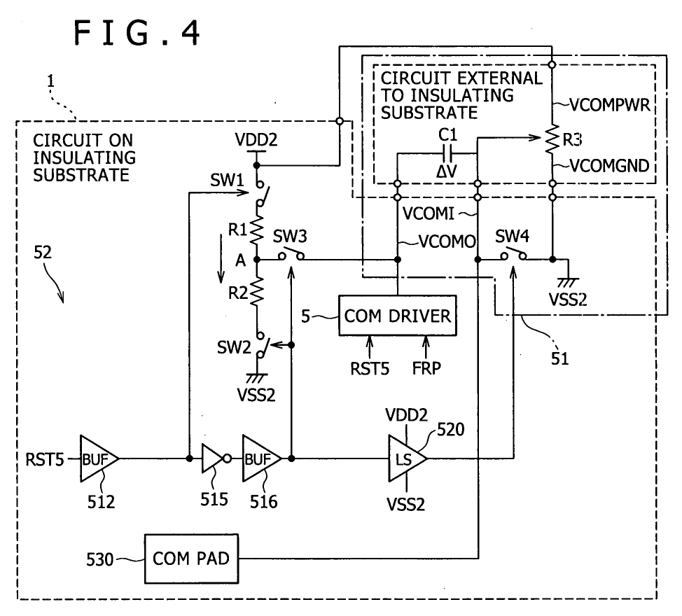

FIG. 4 is a circuit diagram showing a concrete example of a configuration of the offset circuit and the start circuit attached to the COM driver 5 shown in FIG. 1. This embodiment uses a normal start circuit that is not ready for the standby mode. As shown in the figure, the offset circuit 51 and the start circuit 52 are laid out with the common driver (COM driver) 5 at a center. The COM driver 5 sends out a common voltage VCOM inverted in polarity according to a predetermined periodic signal FRP to an output node VCOMO. In the present embodiment, the periodic signal FRP defines a frame period. The COM driver 5 is logically reset by an internal reset signal RST5.

The offset circuit 51 has a coupling capacitor C1 for generating a predetermined offset voltage ΔV to adjust the level of the common voltage with respect to the signal voltage. This coupling capacitor C1 is an external part, and it is mounted on another substrate than the insulating substrate 1 where the panel is incorporated. In addition, the offset circuit 51 includes a variable resistance R3 and a switch SW4 formed by a thin film transistor. The variable resistance R3 is an external part. The switch SW4 is included in the circuit on the insulating substrate 1. The offset common voltage VCOM appearing at a node VCOMI of the coupling capacitor C1 is supplied to a common electrode pad (COM pad) 530 via wiring formed on the insulating substrate 1.

The start circuit 52 pre-charges the coupling capacitor C1 of the offset circuit 51 to the offset voltage ΔV at a time of a rising edge of the power supply voltage, and discharges the coupling capacitor C1 at a time of a falling edge of the power supply voltage. The start circuit 52 is an integrated internal circuit formed on the insulating substrate 1. The start circuit 52 includes a buffer (BUF) 512 to which the internal reset signal RST5 is input, an inverter 515, a buffer 516, a level shifter 520 and the like. The start circuit 52 further includes resistances R1 and R2 connected in series with each other between a positive-side power supply voltage VDD2 and a negative-side power supply voltage VSS2. An intermediate node A between the resistances R1 and R2 is connected to the node VCOMO via a switch SW3. In addition, a switch SW1 is interposed on an upper side of the resistance R1, and a switch SW2 is interposed on a lower side of the resistance R2. As is clear from the above configuration, almost all parts of the COM driver 5, the offset circuit 51 and the start circuit 52 are formed in an integrated manner on the insulating substrate 1, and only the coupling capacitor C1 and the variable resistance R3 are external parts.

Continuing referring to FIG. 4, description will be made of an on sequence of the start circuit 52 at a time of turning on power. In a first stage, the power supply voltage VDD2 of the display device rises. Thereby the switches SW1, SW2, SW3, and SW4 are brought into a conducting state. The VDD2 is divided by the series resistances R1 and R2, so that the node A is at an intermediate potential ΔV. Since the switches SW3 and SW4 are also in a conducting state, the node VCOMO is at the same potential as the node A, so that the coupling capacitor C1 is charged. The ratio between the series resistances R1 and R2 is set such that a potential difference of the node A and the node VCOMO is ΔV.

In a second stage, the driving circuit reset signal RST5 within the display device rises. Thereby the COM driver 5 within the display device becomes active to output an alternating-current common voltage. At this time, the switches SW1, SW2, SW3, and SW4 are brought into a non-conducting state in response to the reset signal RST5. Since the coupling capacitor C1 is sufficiently charged with electric charge in the first stage, the output of the COM driver 5 is coupled to output a potential resulting from a DC shift of the output of the COM driver 5 by ΔV to the node VCOMI. The variable resistance R3 is set such that the potential of the node VCOMI is shifted by ΔV. In a subsequent third stage, a display start signal PCI rises, so that an image appears in the display area.

An off sequence of the start circuit 52 will next be described. In a first stage, the display command PCI falls, so that a screen in the display area is brought into a non-display state. In a following second stage, the driving circuit reset signal RST5 within the display device falls. Thereby the switches SW1, SW2, SW3, and SW4 are brought into a conducting state. The switch SW1 is formed by a PMOSTFT, and the SW2, SW3, and SW4 are formed by an NMOSTFT. On the other hand, the COM driver 5 within the display device becomes inactive. The power supply potential VDD2 is divided by the series resistances R1 and R2 to provide the intermediate potential ΔV at the node A. Since the SW4 is in a conducting state, the node VCOMI is at a GND level. Thereby the coupling capacitor C1 is discharged. In a subsequent third stage, the power supply voltage VDD2 falls.

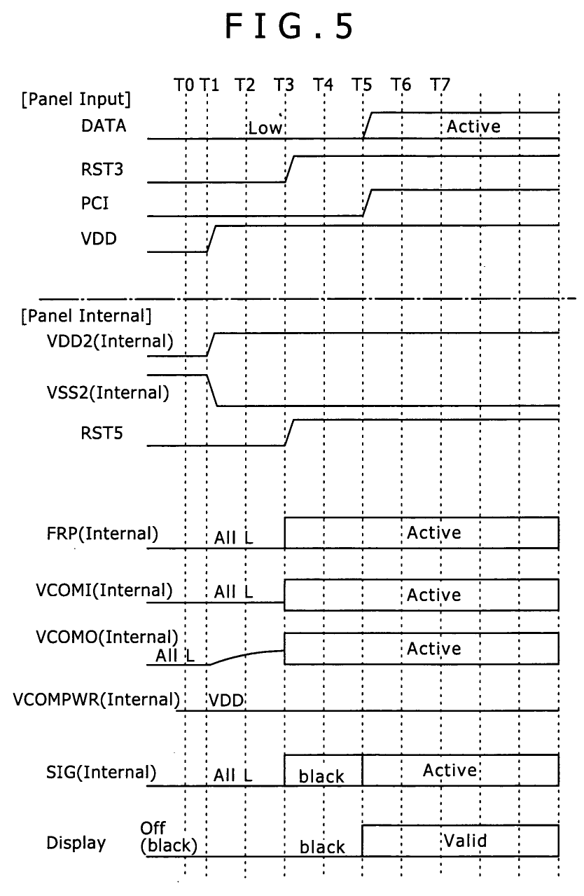

FIG. 5 is a timing chart of the above-described on sequence. A part on an upper side of alternate long and short dashed lines represents state changes of display data DATA, a reset signal RST3, a display start signal PCI, and power supply voltage VDD input from the set side to the panel side. A part on a lower side of the alternate long and short dashed lines represents state changes of a power supply line, nodes, internal signals and the like occurring within the panel. As shown in the figure, the power supply voltage VDD is supplied from the set side in timing T1, the reset signal 3 for initialization is input in timing T3, and the display data DATA and the display start signal PCI are input in timing TS. Meanwhile, within the panel, the positive-side power supply voltage VDD2 and the negative-side power supply voltage VSS2 are set in timing T1. Thereby the start circuit starts operation to charge the coupling capacitor C1. As the coupling capacitor C1 is charged, the potential of the node VCOMO rises. The node VCOMO rises to a predetermined offset potential ΔV in timing T3. In synchronism with this, the periodic signal FRP becomes active, and signal potential is set to a black level. Further, in timing T5, the signal potential SIG is changed from the black level to an active state, and the display becomes valid.

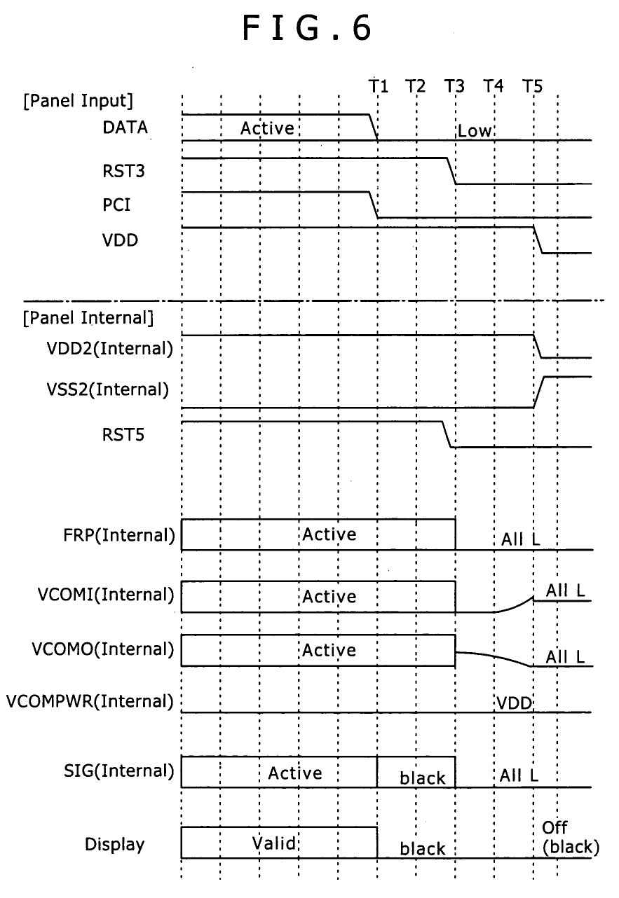

FIG. 6 is a timing chart of the above-described off sequence. In timing T1, the display data DATA and the display command PCI from the set side fall to a low level. Further, the reset signal RST3 falls to a low level in timing T3, and thereafter the power supply voltage VDD falls to a low level in timing T5. In synchronism with this, within the panel, the signal voltage SIG is changed from an active state to a black level, and a display state is changed from a valid state to a black display. Further, in timing T3, the internal reset signal RST5 falls, so that discharging of the coupling capacitor begins. Thereby the potential of the node VCOMO is gradually lowered and reaches a low level in timing T5. In synchronism with this, the power supply voltages VDD2 and VSS2 are shut off.

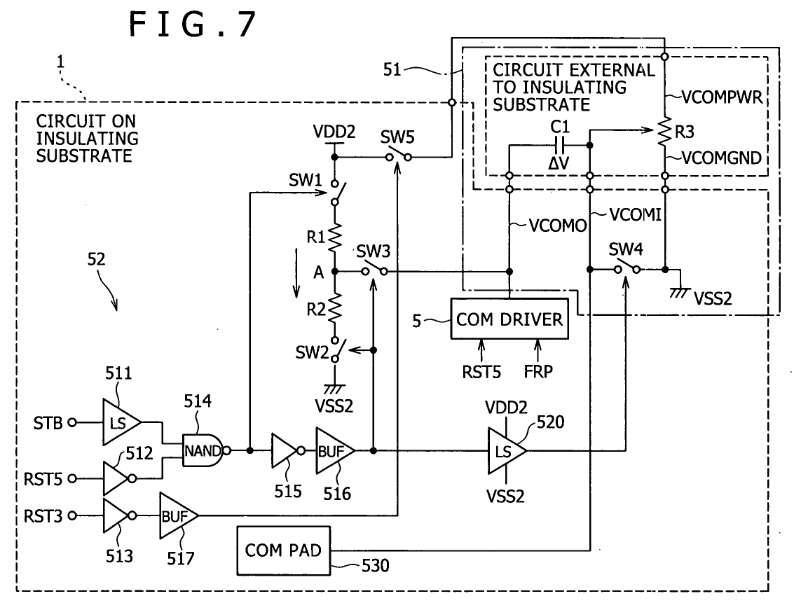

FIG. 7 is a circuit diagram showing an embodiment of a start circuit 52 having a standby mode. In order to facilitate understanding, parts corresponding to those in the foregoing start circuit shown in FIG. 4 are identified by corresponding reference numerals. A system display having a standby mode does not shut off power supply voltage VDD even when making a transition from an operational mode to a standby mode. Accordingly, the start circuit 52 is controlled by a standby signal STB as a substitute for the power supply VDD.

As in the foregoing embodiment shown in FIG. 4, the COM driver 5 applies a common voltage VCOM to the common electrode. An offset circuit 51 has a coupling capacitor C1 for generating a predetermined offset voltage ΔV to adjust the level of the common voltage relative to the signal voltage. The start circuit 52 pre-charges the coupling capacitor C1 of the offset circuit 51 to the offset voltage ΔV at a time of a rising edge of the power supply voltage VDD2, and discharges the coupling capacitor C1 at a time of a falling edge of the power supply voltage VDD2. As shown in the figure, the COM driver 5, the offset circuit 51, and the start circuit 52 are mounted on a common insulating substrate 1 except the coupling capacitor C1 and a variable resistance R3.

In addition to the above-described coupling capacitor C1, the offset circuit 51 includes a transistor switch SW4 and the variable resistance R3 for voltage level adjustment. The resistance R3 is an external part as with the coupling capacitor C1. The transistor switch SW4 is formed on the insulating substrate 1. A common voltage VCOMI that has been subjected to an offset process and input from the coupling capacitor C1 external to the insulating substrate 1 is connected via internal wiring to a COM pad 530, which is connected to the common electrode within the system display.

The start circuit 52 includes logical circuits, such as a level shifter 511, to which a standby signal STB is input, an inverter 512 to which an internal reset signal RST5 is input, an inverter 513 to which an external reset signal RST3 is input, a NAND element NAND 514, an inverter 515, a buffer (BUF) 516, a buffer 517, a level shifter 520 and the like. The start circuit 52 further includes switches SW1, SW2, SW3, and SW5 formed by a thin film transistor. In addition, the start circuit 52 includes a pair of resistances R1 and R2 connected in series with each other between a positive side power supply voltage VDD2 and a negative side power supply voltage VSS2. A point of connection between the resistances R1 and R2 is represented by a node A.

Continuing to refer to FIG. 7, a description will be made of an on sequence and an off sequence of the start circuit 52. In a first stage of the on sequence in which a return from the standby mode to the operational mode is made, the STB signal rises from a low to a high. Thereby, the switches SW1, SW2, SW3, and SW4 are brought into a conducting state. The power supply voltage VDD2 is divided by the series resistances R1 and R2, so that a desired intermediate potential is obtained at the node A. This intermediate potential is equal to a required offset voltage ΔV. Since the switches SW3 and SW4 are in a conducting state, a node VCOMO is at the same potential as the node A, so that the coupling capacitor C1 is pre-charged. The ratio between the series resistances R1 and R2 is set such that a potential difference of the node A and the node VCOMO is ΔV. In a subsequent second stage, reset signals RST3 and RST5 rise. Thereby the COM driver 5 becomes active. At the same time, the switches SW1, SW2, SW3, and SW4 are brought into a non-conducting state. On the other hand, the switch SW5 is brought into a conducting state. Thus, the VDD2 is obtained at a node VCOMPWR, and a current flows through the variable resistance R3. Since the coupling capacitor C1 is sufficiently charged with electric charge in the first stage, the output of the COM driver 5 is coupled to output a potential resulting from a DC shift of the output of the COM driver 5 by ΔV to a node VCOMI. The variable resistance R3 is set such that the potential of the node VCOMI is shifted by exactly ΔV. In a subsequent third stage, a display start signal rises, so that an image appears in the display area.

An off sequence for making a transition from the operational mode to the standby mode will be described next. In a first stage, the display command PCI from the set side falls, so that an image disappears from the display area. In a following second stage, the reset signals RST3 and RST5 fall. Thereby the switches SW1, SW2, SW3, and SW4 are brought into a conducting state. On the other hand, the SW5 is brought into a non-conducting state. Thereby, no current flows through the external variable resistance R3, whereby a desired power-saving effect is obtained. The COM driver 5 within the insulating substrate 1 becomes inactive at the same time, whereby a power-saving effect is obtained. Since the switches SW1 and SW2 conduct, the series resistances R1 and R2 convert the power supply potential VDD2 into a desired intermediate potential at the node A. At this time, since the SW4 is in a conducting state, the node VCOMI is at a GND level. Thereby the coupling capacitor C1 is discharged. Finally, in a third stage, the STB signal falls to bring the switches SW1, SW2, SW3, and SW4 into a non-conducting state. Thereby, the series resistances R1 and R2 are disconnected from the positive-side power supply voltage VDD2 and the negative-side power supply voltage VSS2 so as to prevent a flow of an unnecessary current. Therefore, a desired power-saving effect is obtained.

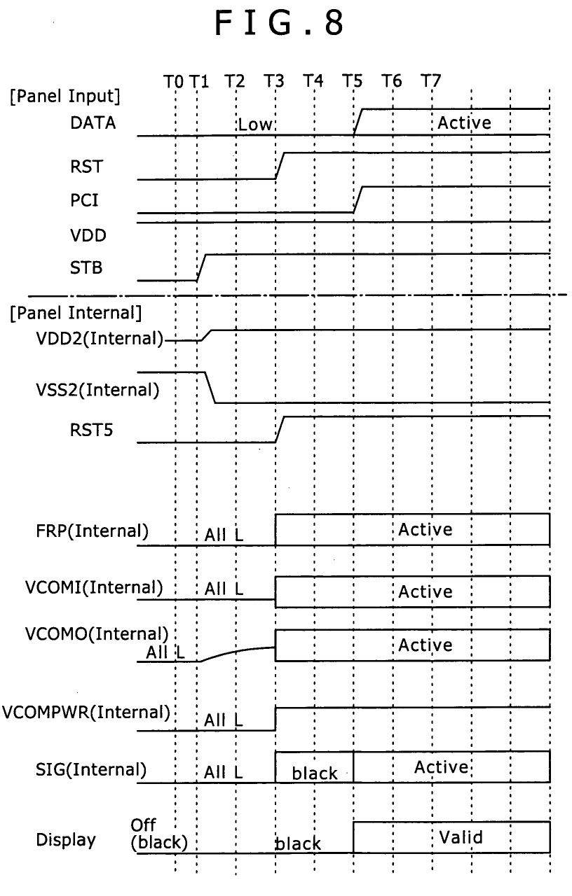

FIG. 8 is a timing chart of the on sequence of the start circuit having the standby mode. When a return is made from the standby mode to the operational mode in the on sequence, the standby signal STB from the set side rises in timing T1. On the other hand, the power supply voltage VDD is maintained at a high level from the beginning. The reset signal RST rises in timing T3, and display data DATA and the display start signal PCI become active in timing TS. In correspondence with this, within the panel, the internal power supply voltages VDD2 and VSS2 are activated in timing T1. Further, in response to the standby signal STB, charging of the coupling capacitor begins, and a potential of the node VCOMO begins to rise to a predetermined offset potential. When the potential of the node VCOMO becomes the predetermined offset potential in timing T3, the internal reset signal RST5 rises to activate the COM driver. Further, in timing T5, signal potential SIG becomes active, and a display becomes valid.

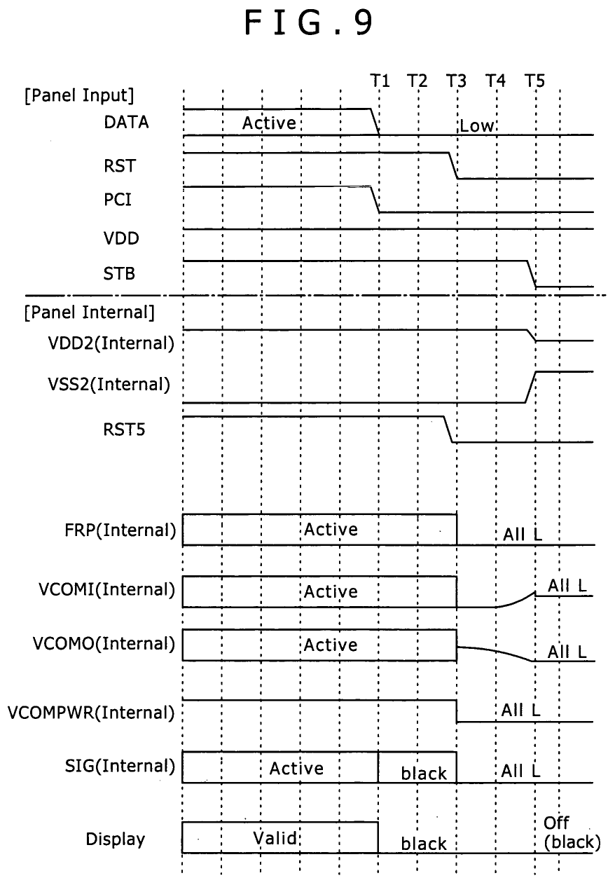

FIG. 9 represents the off sequence of the start circuit having the standby mode. When a transition is made from the operational mode to the standby mode, this off sequence is performed. Unlike the off sequence at a time of shutting off power, the VDD is maintained, while the standby signal STB falls from a high level to a low level in timing T5. Before timing T5, the reset signal RST falls in timing T3. In response to this, discharging of the coupling capacitor within the panel begins, and the potential of the node VCOMO is lowered to a low level.

### INDUSTRIAL APPLICABILITY

As described above, the present invention provides a start circuit for quickly charging a coupling capacitor at a time of turning on power. It is thereby possible to suppress image flicker and the like, and thus achieve high image quality. In particular, the start circuit for quickly charging the coupling capacitor for a common voltage DC shift at a time of turning on power is included on an insulating substrate, whereby the set size and cost can be reduced. Also, in a display system having a standby mode, a start circuit for quickly charging and discharging a coupling capacitor for a common voltage DC shift according to change in a standby signal is provided, whereby the occurrence of flicker and the like can be reduced. In addition, by mounting such a start circuit on an insulating substrate, the size and cost of a set having a lower power consumption mode can be reduced.

1. A display device used as a display part of an electronic device, operating according to display data and power supply voltage supplied from a side of the electronic device proper, and formed by a panel in which a display area and a peripheral circuit part for driving the display area are integrally formed in an integrated manner on an insulating substrate, said display device characterized in that:
said display area comprises pixel electrodes arranged in a form of a matrix, a common electrode opposed to the pixel electrodes, and an electrooptic material retained between the pixel electrodes and the common electrode; and
said circuit part comprises;
a driver for writing a signal voltage to a side of the pixel electrodes according to the display data,
a common driver for applying a common voltage to a side of the common electrode,
an offset circuit having a coupling capacitor for generating a predetermined offset voltage to adjust a level of the common voltage with respect to the signal voltage, and
a start circuit for pre-charging the coupling capacitor of the offset circuit to an offset voltage at a time of a rising edge of the power supply voltage, and discharging the coupling capacitor at a time of a falling edge of the power supply voltage.

2. The display device as claimed in claim 1, characterized in that:
the display area and the peripheral circuit part for driving the display area in said panel comprise thin film transistors formed on a common insulating substrate by an identical process; and
said common driver, said offset circuit, and said start circuit are mounted on the common insulating substrate except for the coupling capacitor.

3. The display device as claimed in claim 1, characterized in that:
said start circuit operates only at the time of the rising edge of the power supply voltage and at the time of the falling edge of the power supply voltage, and it is in a non-operational state during other times.

4. A display device used as a display part of an electronic device capable of switching between a normal power consumption state and a low power consumption state, operating according to display data and power supply voltage supplied from a side of the electronic device proper, and formed by a panel in which a display area and a peripheral circuit part for driving the display area are integrally formed in an integrated manner on an insulating substrate, said display device characterized in that:
said panel can switch between an operational mode and a standby mode according to the switching of the side of the electronic device proper between the normal power consumption state and the low power consumption state;
in the operational mode, the panel operates while supplied with the power supply voltage from the side of the electronic device proper, and makes a desired display by driving the display area;
in the standby mode, the panel has standby control means for stopping the driving of the display area and inactivating the circuit part to reduce power consumption of the panel while the panel remains in a state of being supplied with the power supply voltage from the side of the electronic device proper;
said display area comprises pixel electrodes arranged in a form of a matrix, a common electrode opposed to the pixel electrodes, and an electrooptic material retained between the pixel electrodes and the common electrode; and
said circuit part comprises;
a driver for writing a signal voltage to a side of the pixel electrodes according to the display data supplied from the side of the electronic device proper,
a common driver for applying a common voltage to a side of the common electrode,
an offset circuit having a coupling capacitor for generating a predetermined offset voltage to adjust a level of the common voltage with respect to the signal voltage, and
a start circuit for pre-charging the coupling capacitor of the offset circuit to an offset voltage in advance when a return is made from the standby mode to the operational mode, and discharging the coupling capacitor when a transition is made from the operational mode to the standby mode.

5. A display device as claimed in claim 4, characterized in that:
the display area and the peripheral circuit part for driving the display area in said panel comprise thin film transistors formed on a common insulating substrate by an identical process; and
said common driver, said offset circuit, and said start circuit are mounted on the common insulating substrate except for the coupling capacitor.

6. The display device as claimed in claim 4, characterized in that:
said start circuit operates only when the return is made from the standby mode to the operational mode and when the transition is made from the operational mode to the standby mode, and it is in a non-operational state during other times.
